(19) United States
(12) Patent Application Publication
(10) Pub. No.: US 2015/0170853 A1
(43) Pub. Date: Jun. 18, 2015

(54) TOUCH MOTION SWITCH

(71) Applicant: HYSONIC. CO., LTD., Ansan-si (KR)

(72) Inventors: Jong Sik Seo, Ansan-si (KR); Min Gi Kim, Ansan-si (KR); Se Jun Chun, Ansan-si (KR); Yong Kyu Kim, Ansan-si (KR)

(73) Assignee: HYSONIC, CO., LTD., Ansan-si (KR)

(21) Appl. No.: 14/395,204

(22) PCT Filed: Jul. 26, 2013
(86) PCT No.: PCT/KR2013/006696

§ 371 Date: Oct. 17, 2014

(30) Foreign Application Priority Data
Aug. 29, 2012 (KR) 10-2012-0094683

(51) Int. Cl. H01H 13/20; H01H 13/10; H01H 13/04

(52) U.S. Cl. CPC H01H 13/20; H01H 13/04; H01H 13/10; H01H 2215/05; H01H 2221/024; H01H 2239/074

(57) ABSTRACT

Disclosed is a touch motion switch, more particularly a touch motion switch which generates vibrations such that a user feels vibrations when touching a switch. The touch motion switch includes: a case having a first guide therein; a vibration unit coupled to the case to be movable vertically and having a second guide movable vertically along the first guide; a resilient member mounted to the case to support the vibration unit and resiliently deformed when the vibration unit is moved vertically; a magnetic force unit inserted into the case; and a coil unit mounted to the second guide, for providing a driving force such that the vibration unit is vertically moved to vibrate by an electromagnetic interaction with the magnetic force unit.

### TECHNICAL FIELD

The present invention relates to a touch motion switch, and more particularly to a touch motion switch which generates vibrations such that a user feels vibrations when touching a switch.

### BACKGROUND ART

Generally, a computer touch technology is called a haptic technology.

Korean Patent No. 10-0877067 discloses a haptic switch for transferring vibrations and various stimuli to a user, and the haptic switch may be applied to input units of various digital devices.

The haptic switch is widely used mainly in small-sized portable terminals, but also may be applied to switches of various electronic devices in vehicles.

FIG. 1 is a view for conceptionally explaining a haptic switch according to the related art.

In the haptic switch according to the related art, two electrodes 32a and 32b contact opposite surfaces of an electro active polymer 31.

Opposite ends of the electro active polymer 31 are fixed to fixing units 33 so as not to be displaced.

In this state, if a voltage is applied to the two electrodes 32a and 32b, the electro active polymer 31 is deformed as shown in FIG. 1.

In detail, if a voltage is applied to the two electrodes 32a and 32b, the electro active polymer 31 is prolonged horizontally, and because movement of the opposite ends of the electro active polymer 31 is restrained, the electro active polymer 31 cannot be prolonged horizontally but is deformed vertically to vibrate.

However, in the haptic switch according to the related art, because vibrations are transferred to the entire switch and a device employing the switch when the vibrations are generated, the vibrations are not concentrated on a contact portion of the user but are dispersed.

In particular, in a steering wheel of a vehicle and a switch of an electronic device, because vibrations of the vehicle basically exist and the switch is large as compared with a general portable terminal switch, it may be difficult for a user to recognize vibrations according to an operation of the switch.

### DISCLOSURE

### Technical Problem

The present invention has been made in an effort to solve the above-mentioned problems, and it is an object of the present invention to provide a touch motion switch which can minimize dispersion of a vibratory force such that a user may easily recognize vibrations during an operation of the switch, thereby increasing the vibratory force.

### Technical Solution

In accordance with an aspect of the present invention, there is provided a touch motion switch including: a case having a first guide therein; a vibration unit coupled to the case to be movable vertically and having a second guide movable vertically along the first guide; a resilient member mounted to the case to support the vibration unit and resiliently deformed when the vibration unit is moved vertically; a magnetic force unit inserted into the case; and a coil unit mounted to the second guide, for providing a driving force such that the vibration unit is vertically moved to vibrate by an electromagnetic interaction with the magnetic force unit.

The first guide protrudes upwards within the case and the magnetic force unit is disposed outside the first guide to be spaced apart from the first guide, and the coil unit is mounted to an outer peripheral surface of the second guide, and a coupling recess into which the first guide is inserted is formed at a lower portion of the second guide.

The touch motion switch further comprises: a fixing unit mounted to the case, for fixing the magnetic force unit. The magnetic force unit includes: a pair of magnets disposed vertically such that the same magnetic poles thereof face each other and disposed outside the first guide to be spaced apart from each other; and magnetic induction bodies disposed between the magnets and at upper and lower ends of the magnets and having magnetic polarities.

The fixing unit includes: a fixing plate mounted to the case and having a first through-hole through which the first guide passes; and a fixing cap mounted to the fixing plate to fix the magnetic force unit vertically, having a second through-hole through which the second guide passes, and having the coil unit therein.

The coil unit includes: a core mounted to an outer peripheral surface of the second guide and disposed in the fixing unit; and a coil wound on the core and to which a current is applied. The upper end and the lower end of the core is disposed to miss the magnetic induction body vertically, and have different magnetic polarities according to a direction of a current applied to the coil.

The vibration unit includes: a carrier in which the second guide protrudes from a lower portion thereof and coupled to the case to be movable vertically; a touch pad mounted to an upper portion of the carrier; and a touch circuit board inserted between the carrier and the touch pad, for applying a current to the coil unit as a user contacts the touch pad.

### Advantageous Effects

The touch motion switch according to the present invention has the following effects.

Because the vibration unit vibrates vertically by driving power due to an electromagnetic interaction of the magnetic force unit and the coil unit while the second guide moves vertically along the first guide, dispersion of the vibrating force is minimized and the vibration force is improved, making it possible to increase recognition of vibrations by the user according to an operation of the switch.

Further, because the second guide is moved vertically along the first guide when the vibration unit vibrates, the vibration unit can be prevented from being shaken laterally and accordingly, dispersion of the vibrating force can be prevented.

Further, because the magnetic force unit is fixed by the fixing unit, the magnetic force unit can be prevented from being separated by a repulsive force of the magnets disposed such that the same polarities thereof face each other.

In addition, because the vibration unit vibrates as a current is applied to the coil due to a contact of the touch pad, the switch can be operated conveniently.

### DESCRIPTION OF DRAWINGS

FIG. 1 is a view for conceptionally explaining a haptic switch according to the related art;

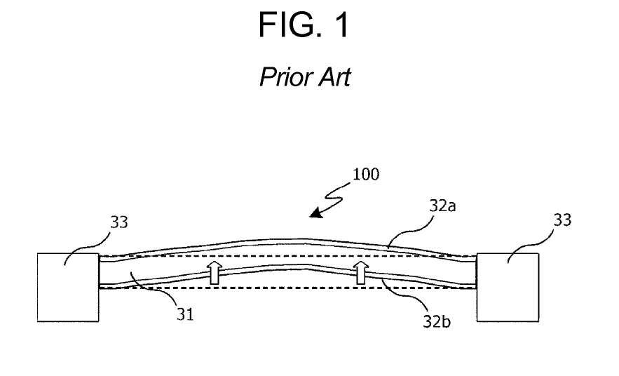

FIG. 2 is a perspective view of a touch motion switch according to an embodiment of the present invention;

FIG. 3 is an exploded perspective view of a touch motion switch according to the embodiment of the present invention;

FIG. 4 is a sectional view taken along line A-A of FIG. 2; and

FIG. 5 is a view showing the touch motion switch according to the embodiment of the present invention.

### BEST MODE

### Mode for Invention

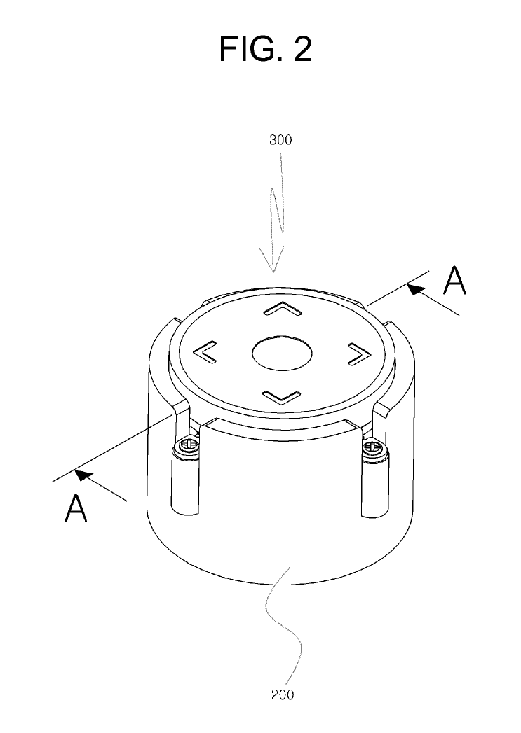

As shown in FIGS. 2 to 4, a touch motion switch according to an embodiment of the present invention includes a case 200, a vibration unit 300, a resilient member 400, a magnetic force unit 500, a fixing unit 600, and a coil unit 700.

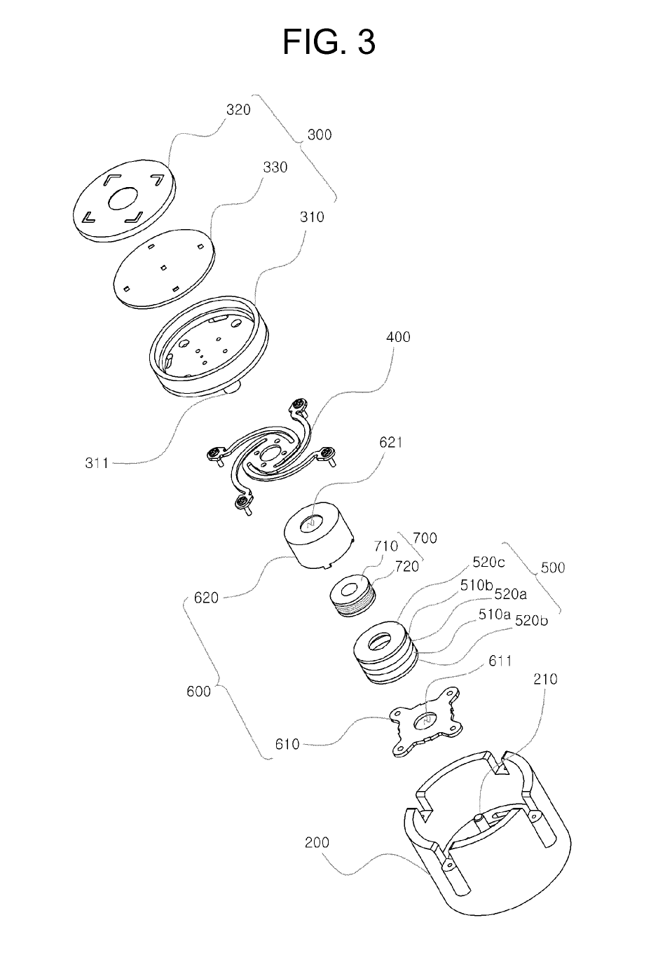

As shown in FIGS. 2 and 3, the case 200 has a cylindrical shape and has an opened upper side such that the vibration unit 300, the resilient member 400, the magnetic force unit 500, the fixing unit 600, and the coil unit 700 are inserted into the case 200.

A first guide 210 is formed within the case 200.

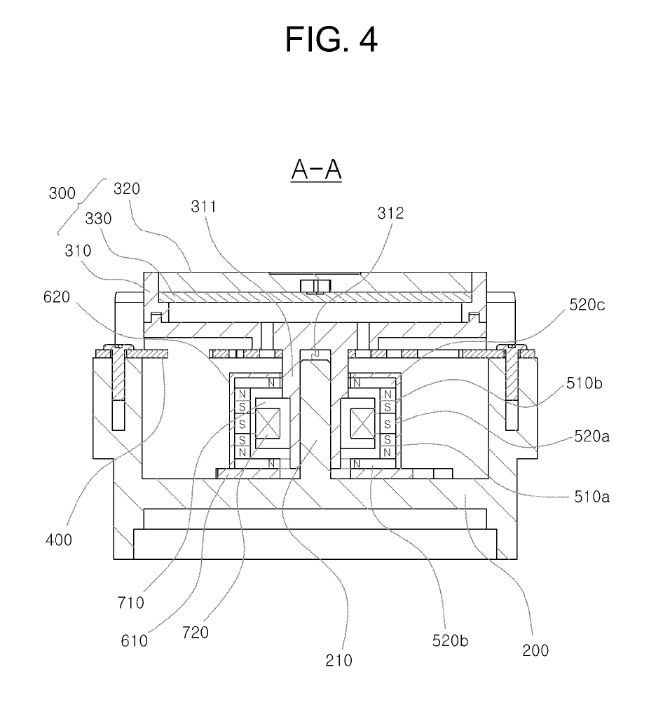

As shown in FIG. 4, the first guide 210 protrudes upwards from an inner lower surface of the case 200 and the magnetic force unit 500 is spaced apart from the first guide 210 on the outer side of the first guide 210.

In the embodiment of the present invention, the case 200 has a cylindrical shape, but the shape of the case 200 is not limited to the embodiment.

The case 200 may be installed in a vehicle to operate a steering wheel and other electronic devices of the vehicle as well as a portable terminal.

The vibration unit 300 is coupled to the case 200 to be moved vertically.

In detail, the vibration unit 300 includes a carrier 310, a touch pad 320, and a touch circuit board 330.

The carrier 310 is supported by the resilient member 400, and is coupled to the case 200 to be moved vertically.

As shown in FIG. 4, a second guide 311 protrudes from a lower portion of the carrier 310, and is supported upwards by the resilient member 400.

The coil unit 700 is mounted to an outer peripheral surface of the second guide 311, and a coupling recess 312 into which the first guide 210 is inserted is formed at a lower portion of the second guide 311.

Thus, when the vibration unit 300 vibrates, the second guide 311 is moved vertically along the first guide 210.

In this way, as the second guide 311 is moved vertically along the first guide 210 when the vibration unit 300 vibrates, the vibration unit 300 can be prevented from being shaken laterally such that a vibratory force can be concentrated on a vertical direction.

The touch pad 320 is mounted to an upper portion of the carrier 310, and is a portion which a user contacts to operate the switch.

The touch circuit board 330 is inserted between the carrier 310 and the touch pad 320 to apply a current to the coil unit 700 as the user contacts the touch pad 320.

If a current is applied to the coil unit 700, the vibration unit 300 vibrates as the second guide 311 is moved vertically along the first guide 210.

Although it has been described in the embodiment of the present invention that the vibration unit 300 vibrates vertically, the vibration direction of the vibration unit 300 may be changed according to a direction in which the case 200 is installed.

The resilient member 400 has a spiral shape, and one end of the resilient member 400 is mounted to the case 200 and an opposite end of the resilient member 400 is mounted to a lower portion of the vibration unit 300 such that the resilient member 400 supports the vibration unit 300 upwards.

If a current is applied to the coil unit 700 and the vibration unit 300 is moved vertically, the resilient member 400 is resiliently deformed, and if a current applied to the coil unit 700 is interrupted, the vibration unit 300 returns to an original position by a resilient restoring force of the resilient member 400.

The magnetic force unit 500 is inserted into the case 200.

In detail, the magnetic force unit 500 includes magnets 510a and 510b and magnetic induction bodies 520a, 520b, and 520c.

The magnets 510a and 510b have annular shapes, and include a first magnet 510a and a second magnet 510b disposed vertically such that the same magnetic pole face each other.

The magnets 510a and 510b are disposed on the outside of the first guide 210 to be spaced apart from each other.

That is, the magnets 510a and 510b are disposed at a circumference of the first guide 210 such that the first guide 210 is located at the center of the magnets 510a and 510b.

The magnetic induction bodies 520a, 520b, and 520c include a first magnetic induction body 520a disposed between the first magnet 510a and the second magnet 510b, a second magnetic induction body 520b disposed at a lower end of the first magnet 510a, and a third magnetic induction body 520c disposed at an upper end of the second magnet 510b.

The magnetic induction bodies 520a, 520b, and 520c have magnetic polarities according to the polarities of the contacting magnets 510a and 510b.

The fixing unit 600 is mounted to the case 200 to fix the magnetic force unit 500.

As described above, because the first magnet 510a and the second magnet 510b get far away from each other by a repulsive force therebetween as the magnets 510a and 510b are disposed such that the same polarities thereof face each other, the first magnet 510a, the second magnet 510b, the first magnetic induction body 520a, the second magnetic induction body 520b, and the third magnetic induction body 520c are fixed by using the fixing unit 600.

In this way, separation of the magnetic force unit 500 is prevented by fixing the magnets 510a and 510b and the magnetic induction bodies 520a, 520b, and 520c with the fixing unit 600.

In detail, as shown in FIG. 3, the fixing unit 600 includes a fixing plate 610 and a fixing cap 620.

The fixing plate 610 is mounted to an inner lower surface of the case 200, and a first through-hole 611 through which the first guide 210 passes is formed in teh fixing plate 610.

Accordingly, the first guide 210 passes through the first through-hole 611 to be disposed within the fixing unit 600.

The fixing cap 620 is mounted to an upper portion of the fixing plate 610 to cover the magnetic force unit 500 to fix the magnetic force unit 500 vertically.

That is, the magnetic force unit 500 is disposed between the fixing plate 610 and the fixing cap 520 to be fixed without being separated vertically.

A second through-hole 621 through which the second guide 311 passes is formed at an upper portion of the fixing cap 620.

Accordingly, the second guide 311 passes through the second through-hole 621 to be inserted into the fixing unit 600, and the first guide 210 is inserted into the coupling recess 312.

The coil unit 700 mounted to the second guide 311 is disposed adjacent to an inside of the magnetic force unit 500 fixed by the fixing unit 600.

The coil unit 700 is mounted to the second guide 311, and provides driving power such that the vibration unit 300 is moved vertically to vibrate due to an electromagnetic interaction with the magnetic force unit 500 if a current is applied to the coil unit 700.

In detail, the coil unit 700 includes a core 710 mounted to an outer peripheral surface of the second guide 311 and disposed within the fixing unit 600, and a coil 720 wound on the core 710.

As shown in FIG. 4, an upper end and a lower end of the core 710 are disposed to vertically miss the magnetic induction bodies 520a, 520b, and 520c, and have different magnetic polarities according to a direction of a current applied to the coil 720.

Hereinafter, an operation of the touch motion switch according to the present invention will be described.

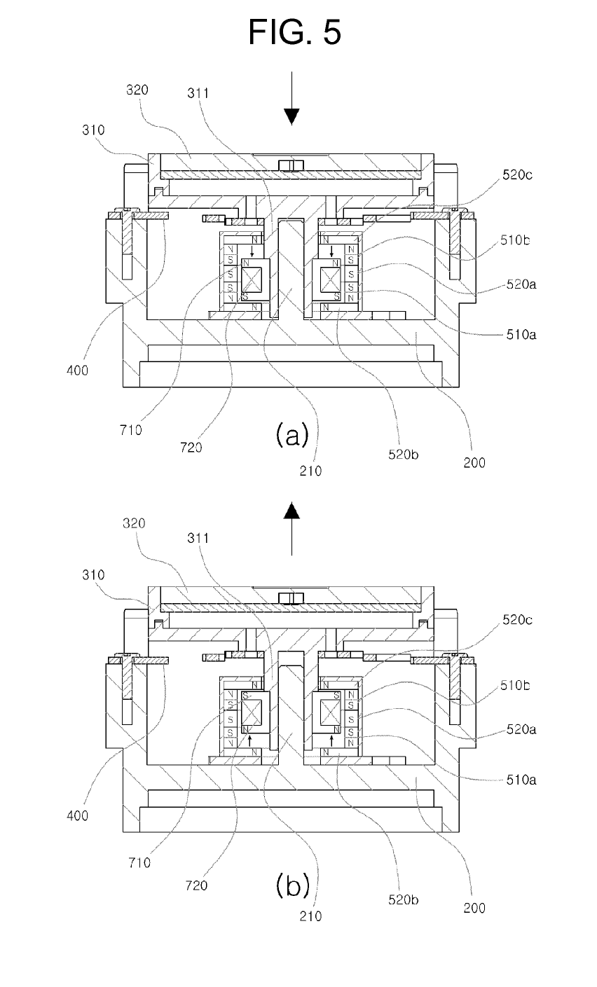

FIG. 5 is a view showing a state in which the vibration unit 300 is raised and lowered.

As described above, the touch motion switch according to the present invention may be installed within a vehicle to operate a steering wheel and various electronic devices of the vehicle as well as a digital device such as a portable terminal to be used.

First, as shown in FIG. 4, the vibration unit 300 is supported by the resilient member 400 and an upper end and a lower end of the core 710 are disposed to vertically miss the magnetic induction bodies 520a, 520b, and 520c.

A current is not applied to the coil 720, and an upper end and a lower end of the core 710 do not have magnetic polarities.

Meanwhile, if a finger of a user contacts the touch pad 320, a current is applied to the coil 720 by the touch circuit board 330.

A direction of a current applied to the coil 720 is periodically changed.

Accordingly, if a current is applied to the coil 720 in one direction, an upper end and a lower end of the coil 710 have different magnetic polarities, and as shown in FIG. 5A, the second guide 311 is moved along the first guide 210 such that the vibration unit 300 is lowered.

Then, the resilient member 400 is resiliently deformed downwards.

Because the driving force generated by the magnetic force unit 500 and the coil unit 700 is stronger than a repulsive force generated when the resilient member 400 is resiliently deformed, the vibration unit 300 is lowered.

If a direction of a current applied to the coil 720 is changed, magnetic polarities of an upper end and a lower end of the core 710 are changed as shown in FIG. 5B, and the vibration unit 300 is raised while the second guide 311 is moved along the first guide 210 by the driving force generated by the magnetic force unit 500 and the coil unit 700.

At the same time, a restoring force of the resilient member 400 is added to the driving force for raising the vibration unit 300 until the resilient member 400 returns to an original position, a repulsive force is generated in a direction opposite to that of the driving force while the resilient member 400 returns to an initial position and is resiliently deformed upwards again.

As described above, because the user feels vibrations as the vibration unit 300 vibrates while the second guide 311 is moved upwards and downwards along the first guide 210, dispersion of vibration forces is minimized and recognition of vibrations by the user according to an operation of the switch can be increased by improving vibrating forces.

The touch motion switch according to the present invention is not limited to the above-described embodiment, but may be variously deformed without departing from the spirit of the present invention.

1. A touch motion switch comprising:
a case having a first guide therein;
a vibration unit coupled to the case to be movable vertically and having a second guide movable vertically along the first guide;
a resilient member mounted to the case to support the vibration unit and resiliently deformed when the vibration unit is moved vertically;
a magnetic force unit inserted into the case; and
a coil unit mounted to the second guide, for providing a driving force such that the vibration unit is vertically moved to vibrate by an electromagnetic interaction with the magnetic force unit.

2. The touch motion switch of claim 1, wherein the first guide protrudes upwards within the case and the magnetic force unit is disposed outside the first guide to be spaced apart from the first guide, and the coil unit is mounted to an outer peripheral surface of the second guide, and a coupling recess into which the first guide is inserted is formed at a lower portion of the second guide.

3. The touch motion switch of claim 1, further comprising:
a fixing unit mounted to the case, for fixing the magnetic force unit,
wherein the magnetic force unit comprises:
a pair of magnets disposed vertically such that the same magnetic poles thereof face each other and disposed outside the first guide to be spaced apart from each other; and
magnetic induction bodies disposed between the magnets and at upper and lower ends of the magnets and having magnetic polarities.

4. The touch motion switch of claim 3, wherein the fixing unit comprises:
a fixing plate mounted to the case and having a first through-hole through which the first guide passes; and
a fixing cap mounted to the fixing plate to fix the magnetic force unit vertically, having a second through-hole through which the second guide passes, and having the coil unit therein.

5. The touch motion switch of claim 3, wherein the coil unit comprises:
a core mounted to an outer peripheral surface of the second guide and disposed in the fixing unit; and
a coil wound on the core and to which a current is applied,
wherein the upper end and the lower end of the core is disposed to miss the magnetic induction body vertically, and have different magnetic polarities according to a direction of a current applied to the coil.

6. The touch motion switch of claim 1, wherein the vibration unit comprises:
a carrier in which the second guide protrudes from a lower portion thereof and coupled to the case to be movable vertically;
a touch pad mounted to an upper portion of the carrier; and
a touch circuit board inserted between the carrier and the touch pad, for applying a current to the coil unit as a user contacts the touch pad.

7. The touch motion switch of claim 2, further comprising:
a fixing unit mounted to the case, for fixing the magnetic force unit,
wherein the magnetic force unit comprises:
a pair of magnets disposed vertically such that the same magnetic poles thereof face each other and disposed outside the first guide to be spaced apart from each other; and
magnetic induction bodies disposed between the magnets and at upper and lower ends of the magnets and having magnetic polarities.

8. The touch motion switch of claim 7, wherein the fixing unit comprises:
a fixing plate mounted to the case and having a first through-hole through which the first guide passes; and
a fixing cap mounted to the fixing plate to fix the magnetic force unit vertically, having a second through-hole through which the second guide passes, and having the coil unit therein.

9. The touch motion switch of claim 7, wherein the coil unit comprises:
a core mounted to an outer peripheral surface of the second guide and disposed in the fixing unit; and
a coil wound on the core and to which a current is applied,
wherein the upper end and the lower end of the core is disposed to miss the magnetic induction body vertically, and have different magnetic polarities according to a direction of a current applied to the coil.

10. The touch motion switch of claim 2, wherein the vibration unit comprises:
a carrier in which the second guide protrudes from a lower portion thereof and coupled to the case to be movable vertically;
a touch pad mounted to an upper portion of the carrier; and
a touch circuit board inserted between the carrier and the touch pad, for applying a current to the coil unit as a user contacts the touch pad.
